(19) United States
(12) Patent Application Publication
(10) Pub. No.: US 2006/0101335 A1
(43) Pub. Date: May 11, 2006

(54) Method and apparatus for generating and storing data and for generating a narrative report

(76) Inventor: Maurice A. Pisciottano, Venetia, PA (US)

Correspondence Address: Brij K. Agarwal;Eckert Seamans Cherin & Mellott, LLC, 44th Floor, 600 Grant Street, Pittsburgh, PA, 15219, US

(21) Appl. No.: 10/984,313

(22) Filed: Nov. 8, 2004

(51) Int. Cl. H04N 11/00

(52) U.S. Cl. 715/531

(57) ABSTRACT

An improved method for generating and storing data involves the use of a computerized device having an input apparatus, a processor apparatus, and an output apparatus. The output apparatus outputs on a display numerous choices, which enables a user to enter data merely by selecting a number of presented choices. Some choices, upon being selected by the user, cause the generation of subsequent choices that have a correspondence with the selected choice. Such subsequent choices may be output at a location adjacent the selected choice so that the user can rapidly make selections. The processor apparatus includes a plurality of textual passages stored in a memory, and the choices presented to the user typically have a correspondence with one of the textual passages. By selecting one of the choices, a textual passage can be output to a file. The file can be output in the form of a narrative report.

### BACKGROUND OF THE INVENTION

1. Field of the Invention

The invention relates generally to data storage systems and, more particularly, to a data storage system that enables the generation and storage of data and that can generate a narrative report as an output.

2. Description of the Related Art

Numerous types of data storage systems are known in numerous different fields. Data storage systems typically enable data to be entered and/or generated, stored, and retrieved. Exemplary data storage systems would include, for instance, computers with databases, electronic files including typewritten notes, paper files including handwritten notes, paper files including pages that each list a plurality of items that may have handwritten check marks beside noted items, and numerous other systems.

Data storage systems are used for many purposes. One exemplary purpose is to maintain records of an individual, such as medical records of a patient, and the like. Medical records oftentimes are either handwritten or are typewritten from dictated notes, and they sometimes can be of a rather cryptic nature. A patient record desirably would be maintained for reasons such as retaining a permanent record of a course of treatment to enable a practitioner to review treatment history during the course of treatment, to enable others practitioners to review and understand the patient history, to store data regarding a course of treatment to enable a practitioner to provide requested data to an insurance carrier, and for other purposes. While such data storage systems have been generally effective for their intended purposes, such data storage systems have not, however, been without limitation.

In some circumstances, the maintenance of complete medical records can be cumbersome for a practitioner. For instance, some courses of medical treatment may require treatments on a daily basis or several times per week. In such a circumstance, the nature of the patient data that should be stored can be extremely repetitive in nature, and thus may be left unrecorded or may be recorded in an extremely limited fashion. Additionally or alternatively, the data may be voluminous and may be only partially recorded or left unrecorded. Such a situation is undesirable since it results in an incomplete record. An incomplete medical record can be problematic for many reasons, including related to professional liability, reasons related to payment by insurance carriers for services rendered, and for other reasons.

With regard to insurance carriers, it is not uncommon for an insurance carrier who has been paying for services during a course of treatment to perform an audit. In the course of an audit an insurance carrier may require a practitioner to provide a complete record of the course of treatment to ensure, for instance, that the course of treatment was in accordance with accepted medical standards. If a practitioner is unable to respond to a request for records from an insurance carrier, or is able to provide only an incomplete record or a record that fails to establish, for instance, the medical necessity of the course of treatment performed, the insurance carrier may insist that the practitioner reimburse the insurance carrier for amounts already paid to the practitioner. This is undesirable for the practitioner for many reasons, particularly because past medical treatments for a patient typically will have actually been, for instance, medically necessary. The practitioner may experience a problem simply because a course of treatment was not recorded in a fashion suitable to the insurance carrier.

It thus would be desirable to provide an improved method and apparatus that facilitate the entry, storage, and retrieval of data such as, for example and without limitation, medical data regarding a course of treatment.

### SUMMARY OF THE INVENTION

An improved method for generating and storing data involves the use of a computerized device having an input apparatus, a processor apparatus, and an output apparatus. The output apparatus outputs on a display numerous choices, which enables a user to enter data merely by selecting a number of presented choices. Some choices, upon being selected by the user, cause the generation of subsequent choices that have a correspondence with the selected choice. Such subsequent choices may be output at a location adjacent the selected choice so that the user can rapidly make selections. The processor apparatus includes a plurality of textual passages stored in a memory, and the choices presented to the user typically have a correspondence with one of the textual passages. By selecting one of the choices, a textual passage can be output to a file. The file can be output in the form of a narrative report that is reflective of the stored data. The method can be employed, for example and without limitation for the storage of medical data, for the storage of maintenance data, and for other data. An improved apparatus and a machine readable medium are also disclosed.

Accordingly, an aspect of the invention is to provide an improved method for keeping records.

Another aspect of the invention is to provide an improved method of entering and/or generating data.

Another aspect of the invention is to provide an improved method of generating a narrative report reflective of stored data.

Another aspect of the invention is to provide an improved method of providing data to another, such as to an insurance company or other entity or individual.

Another aspect of the invention is to provide an improved method and apparatus for increasing the quantity and quality of relevant data regarding a course of medical treatment on a patient.

Another aspect of the device is to provide an improved apparatus that enables complex information to be entered by providing various choices to a user, with a selection of certain choices resulting in subsequent related choices being presented to the user for selection.

Another aspect of the invention is to provide a method and an apparatus for the generation and storage of data wherein initial choices are presented for selection by a user, and with a selection of one of the choices resulting in the generation of additional choices that are output adjacent the selected choice in order to enable a rapid visual association by the user for selection of such subsequent choices.

Another aspect of the invention is to provide an apparatus and method for generating thorough records concerning a course of medical treatment, with the records being generated by the selection of various choices presented to a practitioner.

Accordingly, an aspect of the invention is to provide an improved method of generating a narrative report in a predetermined format with a computerized device. The computerized device includes an input apparatus, an output apparatus, and a processor apparatus, with the output apparatus including a display. The processor apparatus includes a processor and a memory, with the memory having a plurality of textual passages stored therein. The general nature of the method can be stated as including outputting on the display a plurality of first choices, detecting a selection input with respect to a first choice from among the plurality of first choices and, responsive to said detecting a selection input, retrieving from among the plurality of textual passages a textual passage that has a correspondence with the first choice. The method further includes adding the textual passage to a file, and outputting at least a portion of the file as a narrative report.

Another aspect of the invention is to provide an improved method of generating a narrative report in a predetermined format with a computerized device. The computerized device includes an input apparatus, an output apparatus, and a processor apparatus, with the output apparatus including a display. The processor apparatus includes a processor and a memory, with the memory having a number of first choices, a number of second choices, and a number of textual passages stored therein. The general nature of the method can be stated as including outputting on the display a plurality of first choices of the number of first choices, detecting a first selection input with respect to a first choice from among the plurality of first choices and responsive to said detecting a first selection input, retrieving a plurality of second choices of the number of second choices. The method further includes outputting on the display the plurality of second choices, detecting a second selection input with respect to a second choice from among the plurality of second choices, retrieving from among the number of textual passages at least a first textual passage that has a correspondence with the second choice, adding the at least a first textual passage to a file, and outputting at least a portion of the file as a narrative report.

Another aspect of the invention is to provide an improved computerized device that is adapted to generate a narrative report in a predetermined format. The general nature of the computerized device can stated as including an input apparatus, an output apparatus, and a processor apparatus. The output apparatus includes a display. The processor apparatus including a processor and a memory, with the memory having a number of first choices, a number of second choices, and a number of textual passages stored therein. The processor is adapted to output on the display a plurality of first choices of the number of first choices and is adapted to detect a first selection input with respect to a first choice from among the plurality of first choices. The processor is adapted to, responsive to detecting a first selection input, retrieve a plurality of second choices of the number of second choices and output on the display the plurality of second choices. The processor is adapted to detect a second selection input with respect to a second choice from among the plurality of second choices and to retrieve from among the number of textual passages at least a first textual passage that has a correspondence with the second choice. The processor is adapted to add the at least a first textual passage to a file and to output at least a portion of the file as a narrative report.

Another aspect of the invention is to provide an improved machine readable medium having stored thereon instruction which, when executed on a computerized device of a type including an input apparatus, an output apparatus, and a processor apparatus, with the output apparatus including a display, and with the processor apparatus including a processor and a memory, the memory having a number of first choices, a number of second choices, and a number of textual passages stored therein, cause the computerized devices to perform operations, the general nature of which can be stated as including outputting on the display a plurality of first choices of the number of first choices, detecting a first selection input with respect to a first choice from among the plurality of first choices and, responsive to said detecting a first selection input, retrieving a plurality of second choices of the number of second choices. The operations further include outputting on the display the plurality of second choices, detecting a second selection input with respect to a second choice from among the plurality of second choices, retrieving from among the number of textual passages at least a first textual passage that has a correspondence with the second choice, adding the at least a first textual passage to a file, and outputting at least a portion of the file as a narrative report.

### BRIEF DESCRIPTION OF THE DRAWINGS

A further understanding of the invention can be gained from the following Description of the Preferred Embodiment when read in conjunction with the accompanying drawings in which:

FIG. 1 is a schematic view of an improved computerized device in accordance with the invention;

FIG. 2 is an exemplary output on the device of FIG. 1;

FIG. 3 is another exemplary output on the device of FIG. 1;

FIG. 4 is another exemplary output on the device of FIG. 1;

FIG. 5 is another exemplary output on the device of FIG. 1;

FIG. 6 is another exemplary output on the device of FIG. 1;

FIG. 7 is another exemplary output on the device of FIG. 1;

FIG. 8 is another exemplary output on the device of FIG. 1;

FIG. 9 is an exemplary narrative report that can be output from the device of FIG. 1;

FIG. 10 is an exemplary flowchart of a method in accordance with an aspect of the invention; and

FIG. 11 is another exemplary flowchart of a method in accordance with an aspect of the invention.

Similar numerals refer to similar parts throughout the specification.

### DESCRIPTION OF THE PREFERRED EMBODIMENT

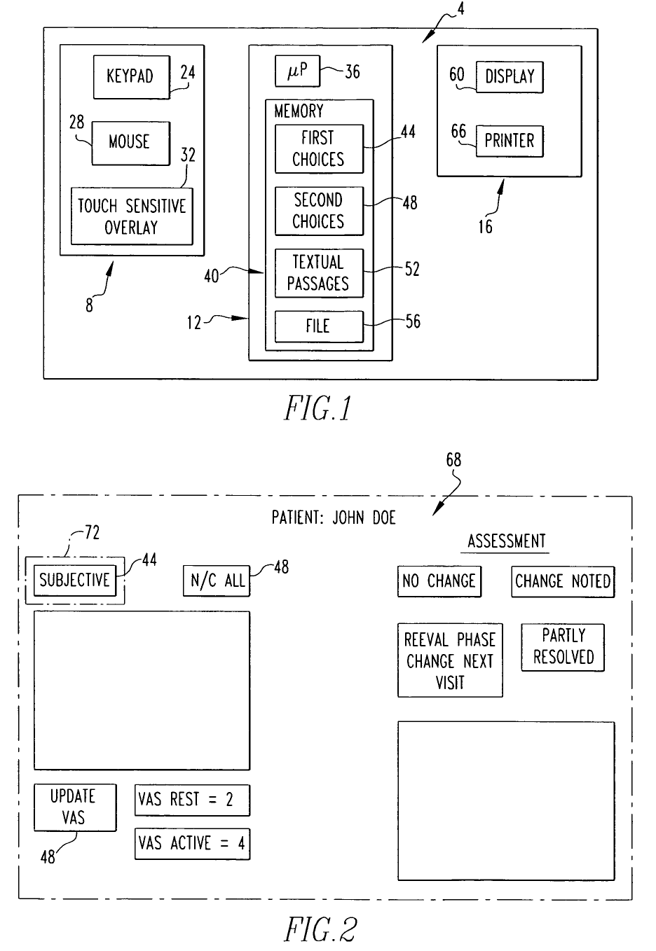

An improved computerized device 4 in accordance the invention is indicated schematically in FIG. 1. The device 4 includes an input apparatus 8, a processor apparatus 12, and an output apparatus 16. The device 4 advantageously facilitates the entry and storage of data and additionally is configured to output data in the form of a narrative report. As employed herein, the expression “narrative” refers generally to language in the form of prose, whether in English or in another language, and that, for example, generally is in the form of complete sentences of text. The device 4 can, for example, be a personal computer, but alternatively could be any of a variety of devices having a computerized interface, such as a personal data assistant (PDA), a cellular telephone, and numerous other types of devices.

The input apparatus 8 includes a keypad 24 and a mouse 28. The input apparatus 8 additionally may include a touch sensitive overlay 32. The keypad 24, the mouse 28, and the touch sensitive overlay 32 can provide various inputs to the processor apparatus 12 and may be replaced with other types of input devices without departing from the concept of the invention.

The processor apparatus 12 includes a processor 36 and a memory 40. The processor 36 may be, for example and without limitation, a microprocessor (μP) or other type of processor. The memory 40 is cooperable with the processor 44 and may be any of a variety of internal and/or external storage media including RAM, ROM, EPROM, EEPROM, and/or the like. The memory 40 includes a plurality of first choices 44, a plurality of second choices 48, and a plurality of textual passages 52 stored therein. The memory 40 also includes at least a first file 56 that can store data.

The memory 40 additionally includes a number of routines that are not expressly depicted herein and that are executable on the processor 36 in order to perform various functions. As employed herein, the expression “a number of” and variations thereof shall refer broadly to any nonzero quantity, including a quantity of one. The memory 40 serves as a machine readable medium that includes data and instructions which, when executed on the processor 36, perform various operations on the device 4. It is noted that such instructions and data may have initially been stored on another machine readable medium prior to being stored in the memory 40, and such other machine readable medium could include, for example and without limitation, magnetic tape, magnetic disks, other memory structures, and the like.

The output apparatus 16 includes a display 60 and may, for example, include another output device such as a printer 64. As a general matter, the processor apparatus 12 receives input from the input apparatus 8 and provides output to output apparatus 16. In the present exemplary embodiment, the input apparatus 8, the processor apparatus 12, and the output apparatus 16 together provide a user interface with which a user can interact to enter, generate, and store data on the device for output in various fashions. The exemplary device 4 depicted herein is employable to enable the entry, generation, storage, and output medical records, but it is understood that other types of records may be entered, generated, stored, and output, such as records related to, for example and without limitation, construction and/or maintenance activities, business activities, and other types of activities. As employed herein, the expression “medical” and variations thereof shall refer broadly to any type of activity or treatment that is of a therapeutic or ameliorative nature and that is performed a practitioner on a recipient, and can include, for example, activities performed by physicians, nurses, dentists, chiropractors, veterinarians, and other types of practitioners.

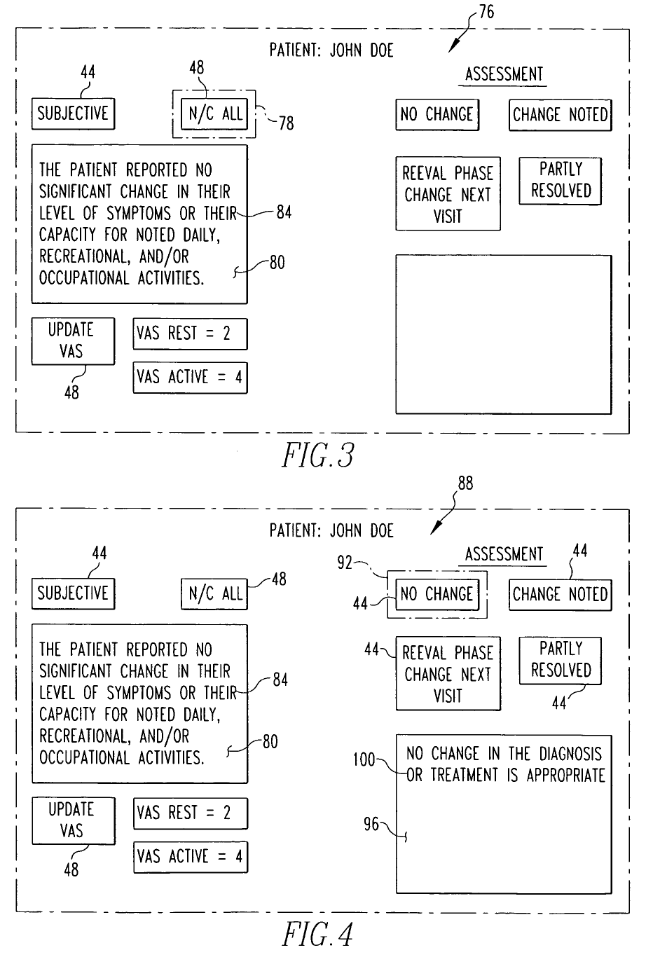

An exemplary first output 68 is depicted generally in FIG. 2. The first output 68 can be output on, for example, the display 60 for viewing by a practitioner or other user. The exemplary first output 68 details a step in a data entry and generation procedure related to a patient named “John Doe” by a practitioner. The first output 68 can include, for example, a first choice 44 and a number of second choices 48 that are depicted on the display 60 as being boxes that can be selectable by a practitioner by providing a selection input with respect to such box. In the exemplary first output 68, the first choice 44 labeled “Subjective” is operative on the device 4, but the second choices 48 labeled “N/C All” and “Update VAS” are not initially active on the device 4. When the processor 36 detects a selection input with respect to the first choice 44 labeled “Subjective”, as is depicted by the box 72 of FIG. 2, the second choices 48 labeled “N/C All” and “Update VAS” are activated and thus can be selected by the practitioner by providing a selection input with respect to one of such second choices 48. The practitioner may select the first choice 44 labeled “Subjective”, i.e., input a selection input with respect to the first choice 44 labeled “Subjective”, if the practitioner desires, for example, to input what the patient believes to be his current subjective condition.

If the patient indicates that, for example, there has been no change in his current subjective condition, the practitioner may select the second choice 48 labeled “N/C All” such as is depicted in FIG. 3 by a box 78. FIG. 3 depicts a second output 76 that is output on the display 60. Upon a detection by the processor 36 of a selection input with respect to the second choice 48 labeled “N/C All”, the processor 36 retrieves from the memory 40 a textual passage 52 that has a correspondence with the second choice 48 labeled “N/C All”. In the present example, the textual passage 52 is a complete sentence that is stored in the file 56 and is output on the display 60 at a first text output location 80. The stored and output textual passage 52 is, in the present example, a first textual passage 84 in the form of a complete sentence as follows: “The patient reported no significant change in their level of symptoms or their capacity for noted daily, recreation, and/or occupational activities.” It thus can be seen that by the practitioner selecting the first choice 44 labeled “Subjective” and the second choice 48 labeled “N/C All”, the device 4 has enabled the generation of the first textual passage 84 which, in the present example, is a complete sentence that is generally in the form of prose. The first textual passage 84 is, for example, stored in the file 56 and is output on the display 60. It is noted that while the textual passage 52 is described herein as being stored in the file 56, such storage need not necessarily be of the entire textual passage 52, and rather could include, for instance, storage of an indicator that would point to the location of storage of the particular textual passage 52 within the memory 40, and the like.

An exemplary third output 88 is depicted generally in FIG. 4 as being output on the display 60. In the third output 88, a plurality of first choices 44 have been output for selection by the practitioner, with the first choices 44 being labeled, for example, “No Change”, “Change Noted”, “ReEval Phase Change”, and “Partly Resolved”. Such first choices 44 may be, for example, simultaneously active on the display 60 and, in the present example, were active and output as a part of the first output 68 of FIG. 2 and second output 76 of FIG. 3. In the exemplary third output 88, the practitioner is depicted as, for example, having selected the first choice 44 labeled “No Change”, which results in the retrieval from the memory 40 of another textual passage 52 that is, for example, stored in the file 56 and is output on the display 60 at a second text output location 96. The output textual passage 52 is a second textual passage 100 that is a narrative passage in the form of a complete sentence reading “No change in the diagnosis or treatment is appropriate.” The second textual passage 100 has thus been generated, i.e., retrieved from the memory 40, and stored in the file 56 upon the selection of the first choice 44 labeled “No Change”. It is understood that a selection by the practitioner of one of the other first choices 44, such as the first choice 44 labeled “Change Noted” likely would have resulted in a different textual passage 52 being retrieved from the memory 40, stored in the file 56, and output on the display 60.

In the present exemplary embodiment, both the first textual passage 84 and the second textual passage 100 are stored in the file 56 and can be output in other fashions, as will be set forth in greater detail below. That is, the input steps described herein and depicted generally in FIGS. 2-4, as well as in other figures, reflects only an exemplary data entry operation, and it is understood that numerous other results would be obtained if other first choices 44 and/or second choices 48 had been selected by the practitioner. Such alternate selections likely would result in different textual passage 52 being retrieved, stored, and output as part of the data entry and generation process.

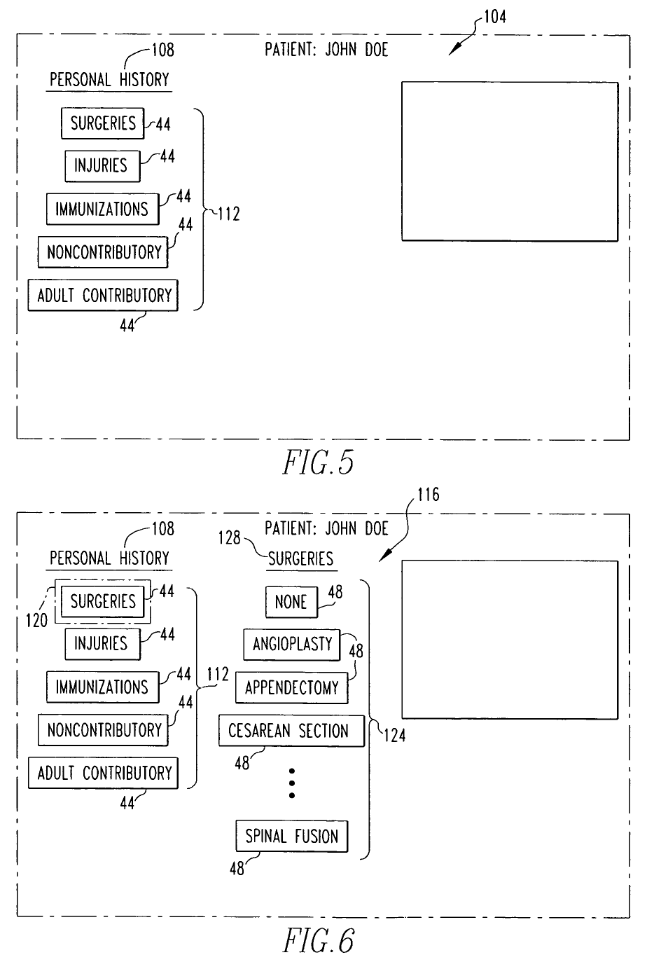

It is further understood that the data entry and generation process by a practitioner typically will involve the entry of much more data than is described herein. For instance, the data entry example provided in FIGS. 2-4 may relate to a visit by a patient to the practitioner subsequent to an initial meeting at which substantial additional information, such as background information and other information had been entered into the device 4 and corresponding text passages 52 and other data generated, retrieved, and stored. For example, a data entry and generation process that may have occurred upon a first meeting between the patient and the practitioner is depicted, in part, and in a general fashion in FIGS. 5-8. More particularly, FIGS. 5-8 generally depict a process by which certain aspects of the patient's personal history are entered into the device 4. In order to enable the entry of a patient's personal history, the processor 36 may output to the display 60 an output such as the fourth output 104 depicted generally in FIG. 5. The fourth output 104 includes, for example, a first heading 108 below which are output a plurality of first choices 44 labeled, “Surgeries”, “Injuries”, “Immunizations”, “Noncontributory”, and “Adult Contributory”.

The first choices 44 are arranged in, for example, a first column 112 that is, for example, vertically oriented on the display 60. During a meeting between the practitioner and the patient, the patient may state that he has not undergone any surgical procedures in the past. The practitioner may have asked a question of the patient regarding surgical history because the practitioner may have believed that the presence or absence of past surgical procedures was relevant to the current course of treatment of the patient. In order to enter such data into the device 4, the practitioner may have selected the first choice 44 labeled “Surgeries”, as is indicated in FIG. 6 by a box 120.

FIG. 6 depicts an exemplary fifth output 116 that can be output on the display 60 by the processor 36 in response to a selection of the first choice 44 labeled “Surgeries”. That is, the fifth output 116 may include, for example, a plurality of second choices 48 that are vertically arranged on the display 60 in a second column 124. The second column 124 is disposed below a second heading 128 and disposed adjacent the first column 112. In the present example, the second heading 128 is labeled “Surgeries”, which is an output of the label on the selected first choice 44, i.e., “Surgeries”. Additionally, the second column 124 is disposed immediately to the right of the first column 112.

The second choices 48 have a correspondence with the selected first choice 44 labeled “Surgeries”, with the output second choices 48 being, for instance, labeled with various types of surgical procedures. By providing the second column 124 adjacent the first column 112, and by providing as the second heading 128 the label of the selected first choice 44, i.e., “Surgeries”, the practitioner is able to quickly associate the output second choices 48 with the selected first choice 44. The practitioner thus can rapidly select one of the second choices 48.

The practitioner therefore can enter information regarding the surgical history of the patient by selecting the first choice 44 labeled “Surgeries”, and by thereafter selecting one of the second choices 48 that has been retrieved from the memory 40 as having a correspondence with the selected first choice 44. In the present example, the second choices 48 are more specific examples of the selected first choice 44.

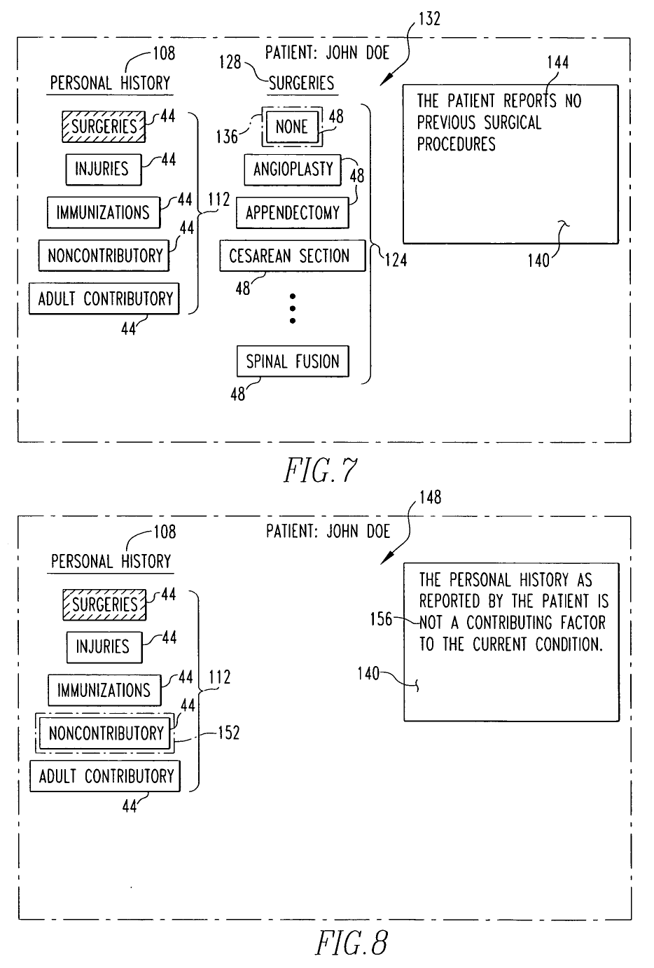

In the present example, the patient has indicated that he has not previously undergone any surgical procedures. The practitioner thus may select, as is generally depicted in FIG. 7, the second choice 48 labeled “None”, as is indicated generally by the box 136. FIG. 7 generally depicts a sixth output 132 that occurs upon selecting the second choice 48 labeled “None”. That is, the processor 36 retrieves from the memory 40 a textual passage 52 that has a correspondence with the label “None” in the context of the selected first choice 44 labeled “Surgery”. Such textual passage 52 is then stored in the file 56 and is output as a third textual passage 144 in a third text output location 140. The third textual passage 144 is a complete sentence that reads “The patient reports no previous surgical procedures.” The practitioner thus has entered, i.e., generated, the aforementioned third textual passage 144, which is in the form of a complete sentence, merely by selecting the first choice 44 labeled “Surgeries” and by selecting the second choice 48 labeled “None” that was output on the display 60 in response to the selection of the first choice 44 labeled “Surgeries.”

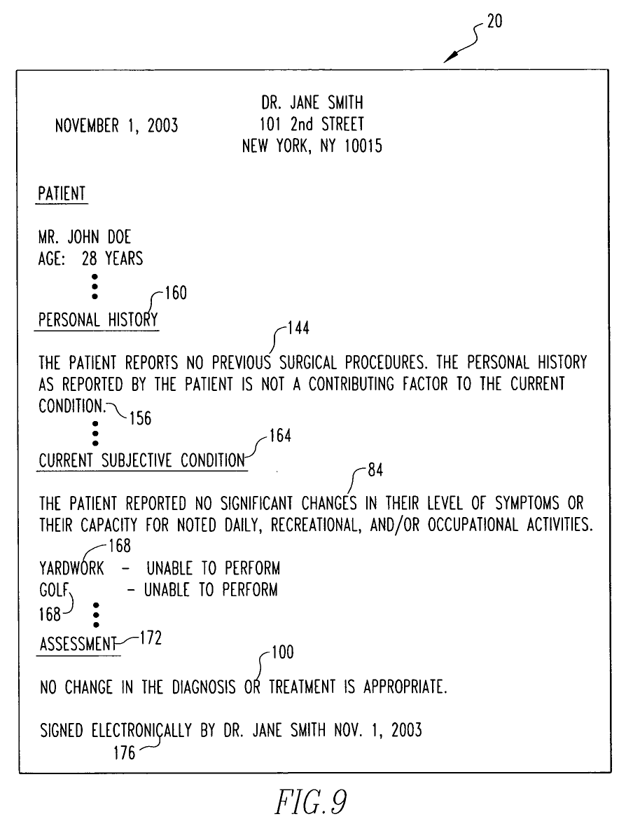

The practitioner may additionally desire to enter a judgment as to the effect of the absence of surgeries on the current condition of the patient. That is, the practitioner may have determined, for example, that the personal history of the patient, including the absence of having undergone surgical procedures, is noncontributory to the current condition of the patient. The practitioner thus may select, as indicated generally in FIG. 8, the first choice 44 labeled “Noncontributory”, as is indicated generally with the box 152 of the seventh output 148. A selection of the first choice 44 labeled “Noncontributory” results in the second choices 44 being removed from the display 60, and further results in the retrieval of a textual passage 52 that corresponds with the first choice 44 labeled “Noncontributory”. The retrieved textual passage 52 is stored in the file 56 and is output at the third text output location 140 as a fourth textual passage 156. The fourth textual passage 156 is, in the present example, a complete sentence: “The personal history as reported by the patient is not a contributing factor to the current condition.” It is noted that the third textual passage 144 has been removed from the third text output location 140, although in the present example the third textual passage 144 remains stored in the file 56. The fourth textual passage 156 is stored in the file 56 in addition to being output at the third text output location 140.

It is noted that the practitioner could have selected the first choice 44 “Noncontributory” without having first selected the first choice 44 labeled “Surgeries” as is described above in the context of FIGS. 6 and 7. In the example presented herein, however, the practitioner chose to enter the surgical history of the patient because, for example, the practitioner believed that the surgical history of the patient, while being noncontributory to the current condition of the patient, was nevertheless relevant to the course of treatment of the patient and was desirably entered into the file 56 on the device 4.

In this regard, it is noted that the practitioner can, as a general matter, input as much data as the practitioner feels is relevant to the course of treatment of the patient. That is, the practitioner may choose to additionally enter information regarding the injury history of the patient, such as by selecting the first choice 44 labeled “Injuries” and by selecting one or more of the second choices 48 that would be responsively output to display 60, for example.

The device 4 is configured, however, to require the entry of certain data in certain circumstances. For example, the device 4 may have required the practitioner to provide some type of input with respect to the personal history of the patient. The device 4 thus may have prevented the practitioner from proceeding beyond the fourth output 104 of FIG. 5 without having selected at least one of the first choices 44. For instance, the practitioner may have determined that the personal history of the patient was noncontributory to the current condition and thus may have selected the first choice 44 labeled “Noncontributory” without entering any other data relevant to the personal history. Such a required entry is dependent upon the ultimate configuration of the device 4 and, for example, relevant requirements by an insurance carrier. That is, the insurance carrier may require a practitioner evaluate a patient's personal history prior to commencing a course of treatment in order to be able to receive payment from the insurance carrier for services rendered or to retain such payments already made in the event of an audit. The device 4 may be configured to require entry of all of the data that would be required, for example, by an insurance carrier in providing reimbursement for treatment services, or by an insurance underwriter who provides liability coverage to the practitioner. The latter circumstance may exist if the underwriter had agreed to provide malpractice coverage to the practitioner only if the practitioner agreed to always evaluate a patient's personal history prior to commencing a course of treatment. In a different context, the device 4 could be configured to store data regarding the repair of airplanes, and the device 4 might be configured to require entry of all repair data that is required by appropriate authorities to be maintained.

The device 4 therefore advantageously enables the rapid entry of information, and additionally can be configured to require the entry of certain information. The entry of such information can, depending upon the nature of the information, be facilitated by providing the first choices 44 and, responsive to a selection of a particular first choice 44, providing a number of the second choices 48 that have a correspondence with the selected first choice 44. For instance, the second choices 48 that are output may be the only second choices 48 that would be relevant to the selected first choice 44.

For instance, a practitioner may make a diagnosis of the patient's condition. The diagnosis may have been, for example, an output first choice 44 from among a plurality of output first choices 44. Upon selecting the particular diagnosis, the device 4 may have additionally output a number of possible treatment plans that would constitute the only treatment plans that would be considered to be medically appropriate for the diagnosis, i.e., being medically necessary and being a treatment for which the insurance carrier would provide a reimbursement. Such a configuration therefore would avoid a mistake by the practitioner in selecting, for example, a course of treatment that was inappropriate for a given diagnosis, such as if the course of treatment were not one that is considered to be medically necessary in light of the diagnosis or, perhaps, being one for which an insurance company would not reimburse the practitioner.

The contents of the file 56 can advantageously be output in a number of fashions. For example, the practitioner can request that a portion of the file 56 be output as the aforementioned narrative report 20. The exemplary narrative report 20 is depicted generally in FIG. 9. For example, the narrative report 20 can include a third heading 160 such as a heading labeled “Personal History”. The narrative report 20 also may include the third textual passage 144 and fourth textual passage 156 output below the third heading 160 in the form of narrative passages that describe the personal history of the patient in a narrative, prose format. The narrative report 20 can include other output, such as a fourth heading 164 labeled, for example, “Current Subjective Condition”, with additional data being output below the fourth heading 164. For instance, the first textual passage 84 may be output below the fourth heading 164, with the first textual passage 84 being a complete sentence, as has been mentioned above.

The narrative report 20 may further include an output of previously saved data 168 such as the notations “Yard Work—Unable To Perform” and “Golf—Unable To Perform” which may have been entered by the practitioner at an earlier time and may have been in another context. For example, the patient may have come to the practitioner because he was suffering from a condition which prevented him from doing yardwork and golf. As mentioned above in the context of FIGS. 2 and 3, the practitioner entered keystrokes that resulted in the generation and storage of the first textual passage 48, which was reflective of no change having occurred in the current subjective condition of the patient. Since no change has occurred, the narrative report 20 may include both a notation of the absence of change in the patient's condition, such as is reflected by the first textual passage 84, and may additionally include the previously saved data 168 which reflects a prior subjective condition which, having been unchanged, is also a current subjective condition.

The narrative report 20 may, for example, additionally include a fifth heading 172 labeled, for example, “Assessment”, with the second textual passage 100 being output below the fifth heading 172. The narrative report 20 may additionally include an electronic signature 176 of the practitioner, and such electronic signature 176 may again be in numerous forms, such as a textual type of form as is presented in the exemplary narrative report 20.

It thus can be seen that the device 4 can receive relatively simple input, such as a number of selection inputs as to various first choice 44 and second choices 48, and based upon such selection inputs the device 4 can output and store in the file 56 numerous textual passages 52 that are reflective of the simple selection inputs. Large amounts of patient data thus can be entered, generated, and stored with a small number of inputs by a practitioner. Similarly, the large amounts of data can be output in a meaningful fashion in the form of the exemplary narrative report 20 for submission, for example, to an insurance carrier in order to obtain a reimbursement from the insurance carrier or to comply with an audit performed by the insurance carrier.

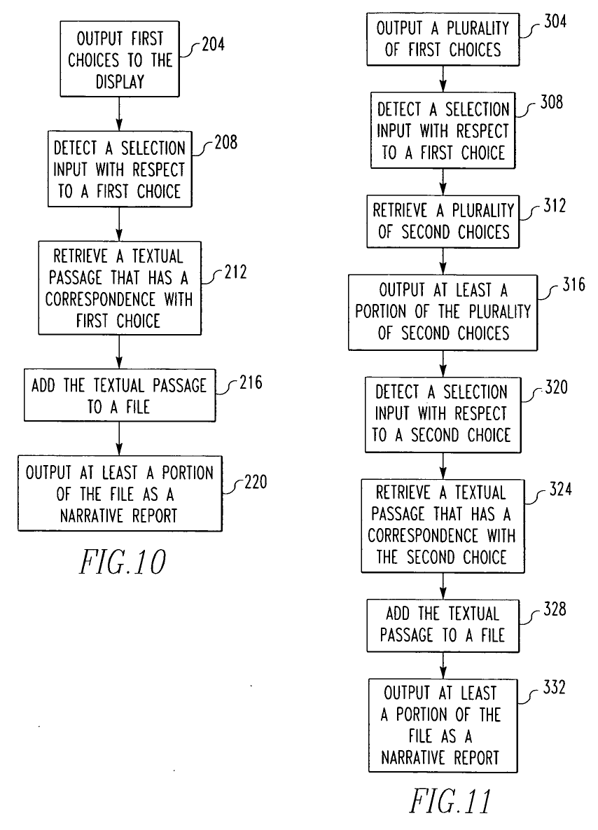

An exemplary aspect of a method in accordance with the invention is described in the flowchart of FIG. 10. The device outputs, as at 204, at plurality of first choices 44 to the display 60. Upon a detection, as at 208, of a selection input with respect to one of the first choices 44, the device 4 retrieves, as at 212, a textual passage 52 that has a correspondence with the selected first choice 44. In the exemplary embodiment depicted herein, the device 4 then adds, as at 216, the retrieved textual passage 52 to the file 56 and additionally outputs, as at 220, at least a portion of the file 56 as a narrative report. In this regard, it is reiterated that in the examples presented herein the portion of the file 56 that has been output as a narrative report would include, for example, the first textual passage 84 output at the first text output location 80, the second textual passage 100 output at the second text output location 96, the third and fourth textual passage 144 and 156 output at the third text output location 140, and the like. The output from the file 56 can be in a narrative form without being in the form of the complete narrative report 20, and additionally need not be the precise data stored in the file 56. As mentioned above, the file 56 may include, for instance, indicators that point to stored textual passages 52. It is further noted that any textual passage 52 that is being output to the display 60 could be considered to be a portion of the file 56 if the textual passage 52, or a pointer thereto, is being stored in the file 56 at substantially the same time as the output to the display 60.

Another aspect of a method in accordance with the invention is indicated generally in the flowchart of FIG. 11. The device 4 outputs, as at 304, a plurality of first choices 44. Upon a detection, as at 308, of a selection input with respect to one of the output first choices 44, the device 4 retrieves, as at 312, a plurality of second choices 48. The second choices 48 typically will have a correspondence with the selected first choice 44, although this is not required in all circumstances. The device 4 then outputs, as at 316, at least a portion of the plurality of retrieved second choices 48. When the processor 4 detects, as at 320, a selection input with respect to one of the output second choices 48, the device 4 retrieves, as at 324, a textual passage 52 that has a correspondence with the second selection 48. The retrieved second passage 52 is added, as at 328, to the file 56. The device 4 then outputs at least a portion of the file 56 as a narrative report, which can be in the form of, for example, the narrative report 20, or it can be, for example, in the nature of the first textual passage 84 output at the first output location 80.

It thus can be seen that the device 4 enables a practitioner to rapidly enter large amounts of data with minimal effort, that is, by entering a few selection inputs. The data can be saved and output in the form of a narrative report. The data can be entered, for example, by selecting a first choice 44 from among a plurality of output first choices 44. In some circumstances, the device 4 will, responsive to a selection of one of the first choices 44, output a plurality of second choices 48 in a location near the selected first choice 44, such as adjacent the output first choices 44. Such a lateral development of output first choices 44, output second choices 48, and additional choices advantageously creates in the mind of the user a logical association between a selection input and a successive output of additional choices. The practitioner entering data can rapidly associate the output second choices 48 with, for example, the selected first input 44. It is noted that the terminology presented herein with respect to first choices 44 and second choices 48 does not limit a sequence of choices to only a pair of selection inputs. Rather, if a given second choice 48 has a plurality of further choices associated therewith, when the second choice 48 is selected it is thereafter considered to be a first choice, with the further choices then being output as second choices to the first choice.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

What is claimed is:

1. A method of generating a narrative report in a predetermined format with a computerized device, the computerized device including an input apparatus, an output apparatus, and a processor apparatus, the output apparatus including a display, the processor apparatus including a processor and a memory, the memory having a plurality of textual passages stored therein, the method comprising:
outputting on the display a plurality of first choices;
detecting a selection input with respect to a first choice from among the plurality of first choices;
responsive to said detecting a selection input, retrieving from among the plurality of textual passages a textual passage that has a correspondence with the first choice;
adding the textual passage to a file; and
outputting at least a portion of the file as a narrative report.

2. The method of claim 1, further comprising storing the first choice.

3. The method of claim 1, further comprising outputting on the display the textual passage.

4. The method of claim 1, further comprising outputting a heading, and outputting the at least a portion of the file as a quantity of narrative text disposed below the heading and having a correspondence with the heading.

5. The method of claim 1, further comprising retrieving as the textual passage a narrative sentence of which the first choice is representative.

6. A method of generating a narrative report in a predetermined format with a computerized device, the computerized device including an input apparatus, an output apparatus, and a processor apparatus, the output apparatus including a display, the processor apparatus including a processor and a memory, the memory having a number of first choices, a number of second choices, and a number of textual passages stored therein, the method comprising:
outputting on the display a plurality of first choices of the number of first choices;
detecting a first selection input with respect to a first choice from among the plurality of first choices;
responsive to said detecting a first selection input, retrieving a plurality of second choices of the number of second choices;
outputting on the display the plurality of second choices;
detecting a second selection input with respect to a second choice from among the plurality of second choices;
retrieving from among the number of textual passages at least a first textual passage that has a correspondence with the second choice;
adding the at least a first textual passage to a file; and
outputting at least a portion of the file as a narrative report.

7. The method of claim 6, further comprising storing the first choice.

8. The method of claim 7, further comprising outputting on the display the first choice.

9. The method of claim 8, further comprising outputting the first choice as a heading on the display, and outputting the plurality of second choices at a location on the display adjacent the heading.

10. The method of claim 6, further comprising outputting a heading, and outputting the at least a portion of the file as a quantity of narrative text disposed below the heading and having a correspondence with the heading.

11. The method of claim 6, further comprising retrieving as the plurality of second choices a plurality of second choices having a correspondence with the first choice.

12. The method of claim 6, further comprising outputting the plurality of second choices at a location on the display adjacent the plurality of first choices.

13. The method of claim 6, further comprising outputting the plurality of first choices in a first vertical column, and outputting the plurality of second choices in a second vertical column, the second vertical column being disposed at a right side of the first vertical column.

14. The method of claim 6, further comprising outputting on the display the at least a first textual passage.

15. A computerized device adapted to generate a narrative report in a predetermined format, the computerized device comprising:
an input apparatus;
an output apparatus including a display; and
a processor apparatus including a processor and a memory, the memory having a number of first choices, a number of second choices, and a number of textual passages stored therein;
the processor being adapted to output on the display a plurality of first choices of the number of first choices;
the processor being adapted to detect a first selection input with respect to a first choice from among the plurality of first choices;
the processor being adapted to, responsive to detecting a first selection input, retrieve a plurality of second choices of the number of second choices;
the processor being adapted to output on the display the plurality of second choices;
the processor being adapted to detect a second selection input with respect to a second choice from among the plurality of second choices;
the processor being adapted to retrieve from among the number of textual passages at least a first textual passage that has a correspondence with the second choice;
the processor being adapted to add the at least a first textual passage to a file; and
the processor being adapted to output at least a portion of the file as a narrative report.

16. A machine readable medium having stored thereon instruction which, when executed on a computerized device of a type including an input apparatus, an output apparatus, and a processor apparatus, the output apparatus including a display, the processor apparatus including a processor and a memory, the memory having a number of first choices, a number of second choices, and a number of textual passages stored therein, cause the computerized devices to perform operations comprising:
outputting on the display a plurality of first choices of the number of first choices;
detecting a first selection input with respect to a first choice from among the plurality of first choices;
responsive to said detecting a first selection input, retrieving a plurality of second choices of the number of second choices;
outputting on the display the plurality of second choices;
detecting a second selection input with respect to a second choice from among the plurality of second choices;
retrieving from among the number of textual passages at least a first textual passage that has a correspondence with the second choice;
adding the at least a first textual passage to a file; and
outputting at least a portion of the file as a narrative report.

17. The machine readable medium of claim 16, wherein the operations further comprise outputting the plurality of second choices at a location on the display adjacent the plurality of first choices.

18. The machine readable medium of claim 16, wherein the operations further comprise outputting the plurality of first choices in a first vertical column, and outputting the plurality of second choices in a second vertical column, the second vertical column being disposed at a right side of the first vertical column.

19. The machine readable medium of claim 16, wherein the operations further comprise outputting on the display the at least a first textual passage.

20. The machine readable medium of claim 16, wherein the operations further comprise retrieving as the plurality of second choices a plurality of second choices having a correspondence with the first choice.
